(19) United States
(12) Patent Application Publication
(10) Pub. No.: US 2019/0176877 A1
(43) Pub. Date: Jun. 13, 2019

(54) ACTUATOR SYSTEM AND ABNORMALITY DETECTOR

(71) Applicant: HITACHI AUTOMOTIVE SYSTEMS, LTD., Ibaraki (JP)

(72) Inventors: Yasuo SUGURE, Tokyo (JP); Mitsuo SASAKI, Hitachinaka-shi (JP)

(73) Assignee: HITACHI AUTOMOTIVE SYSTEMS, LTD., Ibaraki (JP)

(21) Appl. No.: 16/326,791

(22) PCT Filed: Mar. 22, 2017
(86) PCT No.: PCT/JP2017/011466

§ 371 Date: Feb. 20, 2019

(30) Foreign Application Priority Data
Sep. 29, 2016 (JP) 2016-191118

(51) Int. Cl. B62D 5/04

(52) U.S. Cl. CPC B62D 5/0484; B62D 3/12; B62D 5/0487; B62D 5/0463

(57) ABSTRACT

An actuator system has an actuator drivable in two directions, first and second actuator control sections to output control signals to the actuator, and an abnormality detection section to control the first and second actuator control sections and the abnormality detection section detects abnormality by making the first actuator control section output a first control signal to drive the actuator in a first direction and making the second actuator control section output a second control signal to drive the actuator in a second direction that is paired with the first direction.

### TECHNICAL FIELD

The present invention relates to an actuator system and an abnormality detector.

### BACKGROUND ART

An actuator indispensable to the operation of a device has a redundant configuration, for example a duplexed system, in order to improve availability.

In Patent Literature 1, there is disclosed a motor vehicle steering system characterized in that: the motor vehicle steering system includes a steering mechanism that is mechanically discontinuous with a steering member and has a plurality of steering actuators to drive a steering shaft, one or more reaction force actuators to give a steering reaction force to the steering member, and first control means and second control means to control a currently-controlled steering actuator and a currently-controlled reaction force actuator respectively in the steering actuators and the reaction force actuators and has a plurality of control systems that allow data communication between both the control means by wired means and wireless means and control the currently-controlled steering actuator and the currently-controlled reaction force actuator on the basis of the data communicated by the wired means or the wireless means; and each of the control systems has disconnection judgment means to judge whether or not the wired means is disconnected and communication switching means to allow data communication by the wired means when the disconnection judgment means does not judge the wired means to be disconnected and switch from the wired means to the wireless means so as to allow the data communication when the disconnection judgment means judges the wired means to be disconnected.

### CITATION LIST

### Patent Literature

Patent Literature 1: Japanese Unexamined Patent Application Publication No. 2004-338563

### SUMMARY OF INVENTION

### Technical Problem

In the invention described in Patent Literature 1, although a communication path by wired means and wireless means is made redundant, the occurrence of a failure in the wireless means is not assumed and abnormality of a redundant configuration cannot be detected.

### Solution to Problem

The actuator system according to a first embodiment of the present invention has an actuator drivable in two directions, first and second actuator control sections to output control signals to the actuator, and an abnormality detection section to control the first and second actuator control sections and the abnormality detection section detects abnormality by making the first actuator control section output a first control signal to drive the actuator in a first direction and making the second actuator control section output a second control signal to drive the actuator in a second direction that is paired with the first direction.

The abnormality detector according to a second embodiment of the present invention is an abnormality detector used in an actuator system having an actuator drivable in two directions and first and second actuator control sections to output control signals to the actuator, the abnormality detector has an abnormality detection section to control the first and second actuator control sections, and the abnormality detection section detects abnormality by making the first actuator control section output a first control signal to drive the actuator in a first direction and making the second actuator control section output a second control signal to drive the actuator in a second direction that is paired with the first direction.

### Advantageous Effects of Invention

The present invention makes it possible to detect abnormality of a redundant configuration.

### BRIEF DESCRIPTION OF DRAWINGS

FIG. 1 is a view showing an appearance of an electric power steering system.

FIG. 2 is a view showing a detailed configuration of an electric power steering system.

FIG. 3 is a flowchart showing the operation of an abnormality detection section.

FIG. 4 is a flowchart showing the operation of a first ECU and a second ECU.

### DESCRIPTION OF EMBODIMENTS

### Embodiment

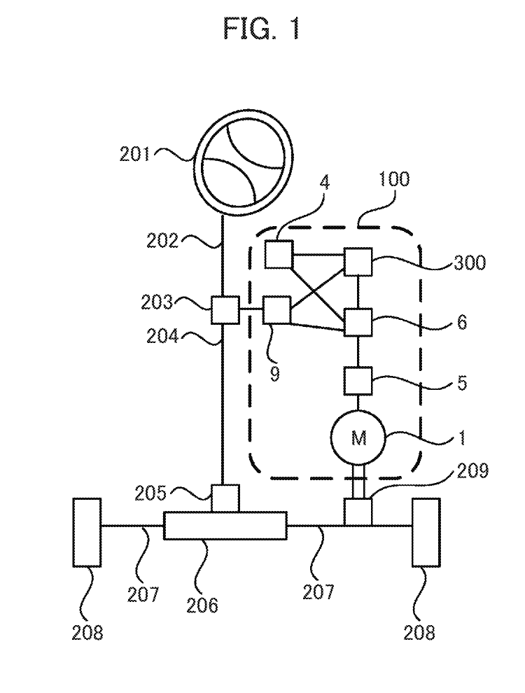

An embodiment of an electric power steering system 100 is explained hereunder in reference to FIGS. 1 to 4.

### Configuration

FIG. 1 is a view showing an appearance of an electric power steering system 100. The electric power steering system 100 assists steering of a steering wheel 201 operated by a user. The electric power steering system 100 has a motor 1, a steering angle sensor 4, an inverter 5, an ECU 6, a steering torque sensor 9, and an abnormality detector 300.

A steering shaft 202 is connected to the steering wheel 201. A pinion shaft 204 is connected to an end of the steering shaft 202 on the side opposite to the steering wheel 201 with a torsion bar 203 interposed. The torsion bar 203 is installed between the steering shaft 202 and the pinion shaft 204. The steering torque sensor 9 detects a steering torque of a user on the basis of a torsional amount of the torsion bar 203. A pinion 205 attached to the tip of the pinion shaft 204 is engaged with rack teeth 206. The rack teeth 206 are attached to a rack bar 207 and steerable wheels 208 are attached to both the ends of the rack bar 207. The rack bar 207 is driven in a linear direction by receiving a driving force from the motor 1 through a decelerator 209. In other words, the motor 1 assists the movement of the rack bar 207 when a user operates the steering wheel 201. The assist of the steering of the steering wheel 201 by the motor 1 is referred to as “steering assist” hereunder.

The steering angle sensor 4 detects a steering angle of the steering wheel 201 by a user by detecting rotation of the steering shaft 202. The steering torque sensor 9 detects a steering torque of a user on the basis of a torsional amount of the torsion bar 203. Since a steering torque is detected by a torsion between the steering shaft 202 and the pinion shaft 204, the steering torque is detected not only when the steering wheel 201 is steered by a user but also when the rotation of the motor 1 is transmitted to the pinion shaft 204. When a user does not hold the steering wheel 201, however, the steering shaft 202 follows easily to the movement of the pinion shaft 204 and hence a steering torque is hardly detected.

The steering angle sensor 4 detects a steering angle of the steering wheel 201 and outputs the steering angle to the abnormality detector 300 and the ECU 6. The ECU 6 operates the motor 1 through the inverter 5 on the basis of outputs of the steering angle sensor 4 and the abnormality detector 300. The steering torque sensor 9 outputs a detected torque to the ECU 6 and the abnormality detector 300.

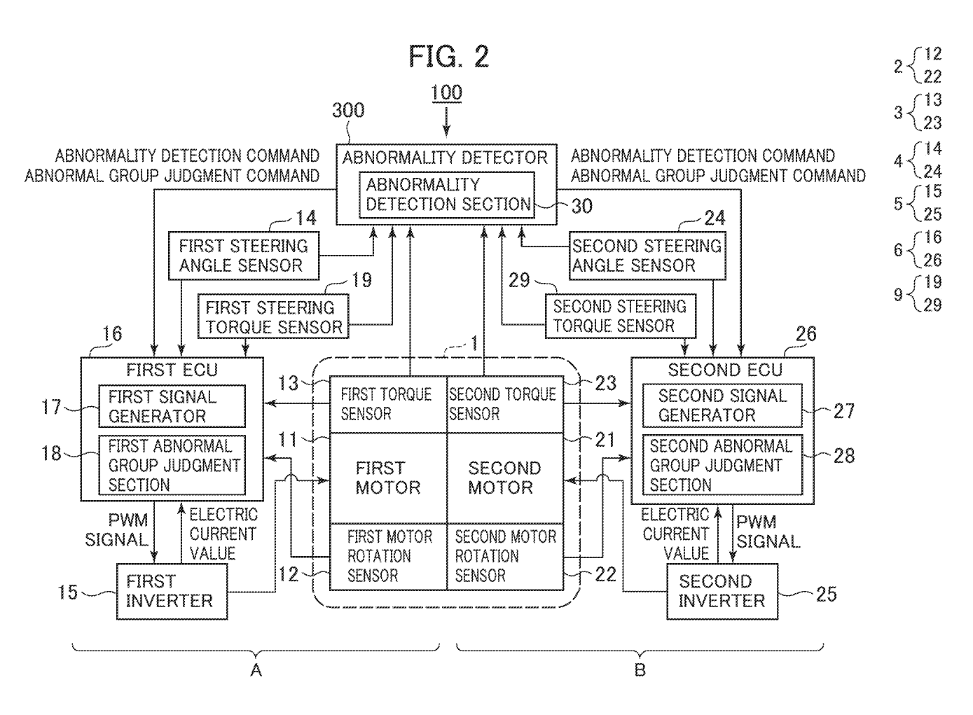

FIG. 2 is a view showing a detailed configuration of an electric power steering system 100. The configuration of the electric power steering system 100 is made redundant and includes a first group A and a second group B and both the groups operate similarly. The electric power steering system 100 has the first group A, the second group B, and an abnormality detector 300.

The first group A includes a first motor 11, a first motor rotation sensor 12, a first motor torque sensor 13, a first steering angle sensor 14, a first inverter 15, a first ECU 16, and a first steering torque sensor 19. The second group B includes a second motor 21, a second motor rotation sensor 22, a second motor torque sensor 23, a second steering angle sensor 24, a second inverter 25, a second ECU 26, and a second steering torque sensor 29. The first ECU 16 has a first signal generator 17 and a first abnormal group judgment section 18. The second ECU 26 has a second signal generator 27 and a second abnormal group judgment section 28.

The first motor 11 and the second motor 21 are two virtual motors and both the physical configurations are comprehended in the motor 1. The first motor 11 and the second motor 21 share a rotor and a stator but do not share wiring wires. The first motor 11 and the second motor 21 have different wiring wire positions. The first motor 11 rotates on the basis of a control signal inputted from the first inverter 15. The second motor 21 rotates on the basis of a control signal inputted from the second inverter 25. The first motor 11 and the second motor 21, however, are virtual motors as stated earlier and are physically the single motor 1. If sinusoidal waves having an identical voltage amplitude, an identical frequency, and phases different by 180 degrees are inputted into the first motor 11 and the second motor 21 simultaneously therefore, both the torques compete with each other and no torques are generated in the motor 1.

Both the first motor rotation sensor 12 and the second motor rotation motor 22 are motor rotation sensors incorporated in the motor 1 and detect a rotation of the motor 1. The mounting positions of the first motor rotation sensor 12 and the second motor rotation sensor 22 are different but the measuring target is the same and hence a measurement result of the other sensor can be calculated from numerical conversion depending on the difference of the mounting positions. The first motor rotation sensor 12 and the second motor rotation motor 22 are collectively referred to as a motor rotation sensor 2 hereunder.

Both the first motor torque sensor 13 and the second motor torque sensor 23 are torque sensors incorporated into the motor 1 and detect a rotation torque of the motor 1. The first motor torque sensor 13 and the second motor torque sensor 23 are collectively referred to as a motor torque sensor 3 hereunder.

The first steering angle sensor 14 and the second steering angle sensor 24 are independent sensors constituting a steering angle sensor 4. Both the first steering angle sensor 14 and the second steering angle sensor 24 detect a steering angle of a steering wheel 201. The steering angle sensor 4 outputs a detected steering angle to the abnormality detector 300 and an ECU 6. The first steering torque sensor 19 and the second steering torque sensor 29 are independent sensors constituting a steering torque sensor 9. Both the first steering torque sensor 19 and the second steering torque sensor 29 detect steering torques on the basis of a torsional amount of a torsion bar 203 shown in FIG. 1.

The first inverter 15 and the second inverter 25 are independent inverters constituting an inverter 5. The first inverter 15 inputs a control signal, for example a sinusoidal wave having predetermined voltage amplitude, frequency, and phase, to the first motor 11 on the basis of an operation command, for example a PWM signal, outputted from the first ECU 16. The second inverter 25 inputs a control signal, for example a sinusoidal wave having predetermined voltage amplitude, frequency, and phase, to the second motor 21 on the basis of an operation command, for example a PWM signal, outputted from the second ECU 26. The inverter 5 feeds back an electric current value to the ECU 6 for feedback control.

The first ECU 16 and the second ECU 26 are independent ECUs constituting the ECU 6. The ECU 6: generates PWM signals on the basis of two kinds of operation commands that are received from the abnormality detector 300 and will be described later; and outputs the PWM signals to the inverter 5. The ECU 16 and the ECU 26 have a time synchronization function and the timers of both the ECUs are synchronized appropriately. As a result, the ECU 16 and the ECU 26 can execute processing requiring consistency of timing as it will be described later.

The first ECU 16 has a CPU, a ROM, a RAM, and a PWM signal aenerating circuit, those being not shown in the figure. The first ECU 16 functions as the first sianal generator 17 and the first abnormal aroup judgment section 18 by making the CPU execute a program stored in the ROM with data stored in the RAM. The first signal aenerator 17 outputs a PWM signal to the first inverter 15 in consideration of an electric current value fed back from the first inverter 15. The first abnormal group judgment section 18 judges which of the first group A and the second group B has an abnormality. The operation of the first abnormal group judgment section 18 will be described later.

The second ECU 26 has a CPU, a ROM, a RAM, and a PWM signal generating circuit, those being not shown in the figure. The second ECU 26 functions as the second signal aenerator 27 and the second abnormal group judgment section 28 by making the CPU execute a program stored in the ROM with data stored in the RAM. The second sianal generator 27 outputs a PWM signal to the second inverter 25 in consideration of an electric current value fed back from the second inverter 25. The second abnormal group judgment section 28 judges which of the first group A and the second group B has an abnormality. The operation of the second abnormal group judgment section 28 will be described later.

The abnormality detector 300 is an ECU having an abnormality detection section 30. The abnormality detector 300 has a CPU, a ROM, and a RAM, those being not shown in the figure, and executes the processing that will be described later as the abnormality detection section 30 by making the CPU execute a program stored in the ROM with data stored in the RAM. Outputs of the motor torque sensor 3 and the steering angle sensor 4 are inputted into the abnormality detector 300. The abnormality detector 300 outputs abnormality detection commands and abnormal group judgment commands that will be described later to the ECU 6.

### Outline of Operation

The processing by the abnormality detection section 30 is roughly classified into abnormality detection processing of detecting the occurrence of a problem and abnormal group judgment processing of judging which group has an abnormality. Firstly, the abnormality detection processing is explained.

Firstly, the abnormality detection section 30: judges whether or not steering assist is effective, in other words whether or not assist for the steering of a steering wheel 201 by the motor 1 is effective; and outputs abnormality detection commands to the ECU 6 and starts the abnormality detection processing when the assist is judged to be ineffective. whether or not steering assist is effective can be judged on the basis of outputs of various sensors and for example outputs of the first motor rotation sensor 12, the first motor torque sensor 13, the first steering angle sensor 14, the first steering torque sensor 19, the second motor rotation sensor 22, the second motor torque sensor 23, the second steering angle sensor 24, and the second steering torque sensor 29 can be used. Judgment may be done on the basis of an output of only one sensor in the above sensors or outputs of multiple sensors.

The ECU 6 that has received abnormality detection commands makes the signal generator 7 output predetermined PWM signals. A control signal which the first inverter 15 outputs by a PWM signal is referred to as a “first control signal” and a control signal which the second inverter 25 outputs by a PWM signal is referred to as a “second control sianal” hereunder. The first control signal and the second control sianal are sinusoidal waves having an identical voltage amplitude, an identical frequency, and phases different by 180 degrees. The first control signal is outputted by the first inverter 15 simultaneously with the output of the second control signal by the second inverter 25. The simultaneity can be materialized as follows for example. That is, information of the time when processing should be executed is inputted into the first ECU 16 and the second ECU 26 from the abnormality detection section 30 and the first ECU 16 and the second ECU 26 output PWM signals at the time. This is because the first ECU 16 and the second ECU 26 have synchronized time information as stated earlier.

The first motor 11 to which the first control sianal is inputted and the second motor 21 to which the second control signal is inputted generate rotation torques respectively. The first motor 11 and the second motor 21 are physically the motor 1 as stated earlier and the motor 1 operates on the basis of the magnitudes of a torque generated by the first motor 11 and a torque generated by the second motor 21. Here, the torques generated by the first motor 11 and the second motor 21 should be at least larger than a loss caused by friction at the bearing part of the motor 1, a so-called friction torque. In the motor 1, both the torques are identical over the entire period if there is no problem in the electric power steering system 100 and hence the torques countervail each other. In other words, the torque generated by the first motor 11 and the torque generated by the second motor 21 offset each other, the motor 1 comes to be in an equilibrium state, and a rotation torque is not generated. If there is some sort of problem in the electric power steering system 100 and both the torques are not identical, however, in other words if both the torques lose balance, a rotation torque is generated in either direction and is detected by the motor torque sensor 3. For example, when the coil resistances of the wiring wires constituting the first motor 11 and the second motor 21 are different by aging too, both the torques do not countervail each other and a torque is detected. Here, in the case where the coil resistances of the first motor 11 and the second motor 21 are different by aging too, a torque is detected likewise.

The abnormality detection section 30: monitors the output of the motor torque sensor 3; judges that an abnormality is detected when the output of the motor torque sensor 3 exceeds a predetermined value, in other word when the motor 1 is not in an equilibrium state; and judges that an abnormality does not occur when the output of the motor torque sensor 3 does not exceed a predetermined value, in other word when the motor 1 is in an equilibrium state. Meanwhile, the abnormality detection section 30 may also judge whether or not the motor 1 is in an equilibrium state by using an output of any one of the motor rotation sensor 2, the steering angle sensor 4, and the steering torque sensor 9 in place of the motor torque sensor 3. For example, it is also possible to: detect at least one of the rotational speed, the rotation amount, and the rotation acceleration of the motor 1 on the basis of an output of the motor rotation sensor 2 or the steering angle sensor 4; and judge whether or not the motor 1 is in an equilibrium state on the basis of the detection result. Further, it is also possible to: detect the rotation torque of the motor 1 on the basis of an output of the steering torque sensor 9; and judge whether or not the motor 1 is in an equilibrium state on the basis of the detection result. Otherwise, it is also possible to: detect a stroke of the rack bar 207; and judge whether or not the motor 1 is in an equilibrium state on the basis of the detection result. That is abnormality detection processing. Successively, abnormal croup judgment processing is explained.

The outline of the abnormal group judgment processing is as follows.

The abnormality detection section 30 that has judged an abnormality to occur through abnormality detection processing outputs an abnormal group judgment command to the ECU 6. The first ECU 16 and the second ECU 26 that have received the abnormal group judgment command output PWM signals for staggering the output timings of a first control signal and a second control signal and outputting the first control signal and the second control sianal to the first inverter 15 and the second inverter 25, respectively. Here, the first ECU 16 and the second ECU 26 may also output PWM sianals for changing a ratio of the magnitudes of a first control signal and a second control signal, in other words a ratio of the magnitudes of a voltage amplitude, from 1:1 to 2:1 or 1:0, in place of staggering the output timings of the first control signal and the second control signal and outputting the first control signal and the second control signal. In the case where a ratio is 1:0, however, if a first group A is judged to have no abnormality on the basis of the first control signal, either a second group B is assumed to have an abnormality or a ratio is set at 0:1 and only the second control signal is outputted again. The first abnormal group judgment section 18 and the second abnormal aroup judgment section 28 judge which of the first group A and the second group B has an abnormality on the basis of the outputted PWM signals and the output of the motor torque sensor 3. Then the first abnormal group judgment section 18 and the second abnormal group judgment section 28 output the judgment result to the abnormality detector 300.

A concrete example of the abnormal group judgment processing is as follows for example.

The first ECU 16 and the second ECU 26 output PWM signals so that a first control signal may be outputted in advance and a second control signal may start to be outputted when the first control signal is outputted for a predetermined period of time. On this occasion, only the first motor 11 operates on the basis of the first control sianal until the second control sianal starts to be outputted and hence a torque corresponding to the operation of the first motor 11 is expected to be detected by the motor torque sensor 3. The first abnormal group judgment section 18 and the second abnormal group judgment section 28 judge that the first group A has an abnormality when the torque detected by the motor torque sensor 3 is different from an assumed torque by a predetermined value or more. When the first abnormal group judgment section 18 and the second abnormal group judgment section 28 judge that the first group A has an abnormality, the first abnormal group judgment section 18 and the second abnormal group judgment section 28 notify the result to the abnormality detector 300. When the first abnormal group judgment section 18 and the second abnormal group judgment section 28 do not judge that the first group A has an abnormality, the first abnormal group judgment section 18 and the second abnormal group judgment section 28 output PWM signals for switching the output timings of a first control signal and a second control signal and outputting the first control signal and the second control signal to the first inverter 15 and the second inverter 25, respectively. In other words, in contrast to the above example, PWM signals are outputted so that the second control signal may be outputted in advance and the first control signal may start to be outputted when the second control sianal is outputted for a predetermined period of time. Then similarly to the above case, the first abnormal Group judgment section 18 and the second abnormal group judgment section 28 judge whether or not the second group B has an abnormality and, when the first abnormal group judgment section 18 and the second abnormal group judgment section 28 judges that the second group B has an abnormality, the first abnormal group judgment section 18 and the second abnormal group judgment section 28 notify the result to the abnormality detector 300.

The abnormality detector 300, when a judgment result is outputted from the ECU 6, stops a processing group that is judged to have an abnormality, in other words the first group A or the second group B. Then subsequently steering assist is executed by using only the processing group not stopped.

### Flowchart

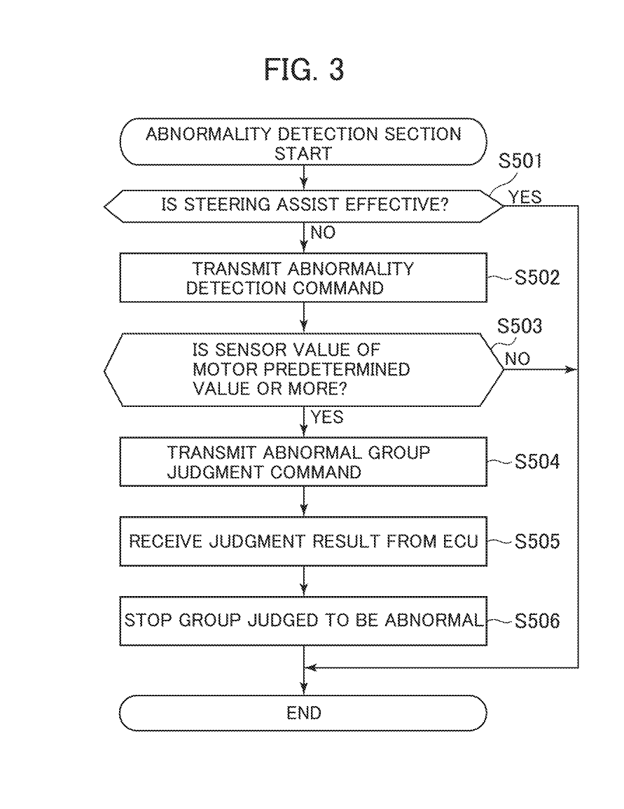

FIG. 3 is a flowchart showing operations of an abnormality detection section 30. A subject that executes the steps explained below is a CPU in an abnormality detector 300. The abnormality detection section 30 operates: at the startup time of a vehicle incorporating an electric power steering system 100, in other words when the power source of electrical components in a vehicle is turned on; and subsequently when the vehicle stops for a predetermined period of time.

At Step S501, the CPU judges whether or not steering assist, in other words assist for the steering of a steering wheel 201 by a motor 1, is effective. Whether or not steering assist is effective can be judged from an output of a steering angle sensor 4 and the operating conditions of the motor 1. The execution of a program showing operations in the flowchart of FIG. 3 is finished when the steering assist is judged to be effective and the process advances to Step S502 when the steering assist is judged to be ineffective.

At Step S502, the CPU transmits an abnormality detection command to an ECU 6. At subsequent Step S503, whether or not an output of a sensor value of the motor 1 is a predetermined value or more is judged. The sensor value is a value of anyone of a first motor torque sensor 13, a second motor torque sensor 23, a first motor rotation sensor 12, and a second motor rotation sensor 22. The process advances to Step S504 when the output of a sensor value is judged to be the predetermined value or more and the execution of the program showing operations in the flowchart of FIG. 3 is finished when the output of a sensor value is judged to be less than the predetermined value. Here, the affirmative judgment at the step means that an abnormality is detected.

At subsequent Step S504, the CPU transmits an abnormal group judgment command to the ECU 6. At subsequent Step S505, the CPU receives a judgment result from the ECU 6. At subsequent Step S506, a group judged to have an abnormality, namely the first group A or the second group B, is stopped on the basis of the judgment result received at Step S505. When either of the groups is judged not to have an abnormality, however, neither of the groups is stopped. After the above steps, the execution of the program showing the operations in the flowchart of FIG. 3 is finished.

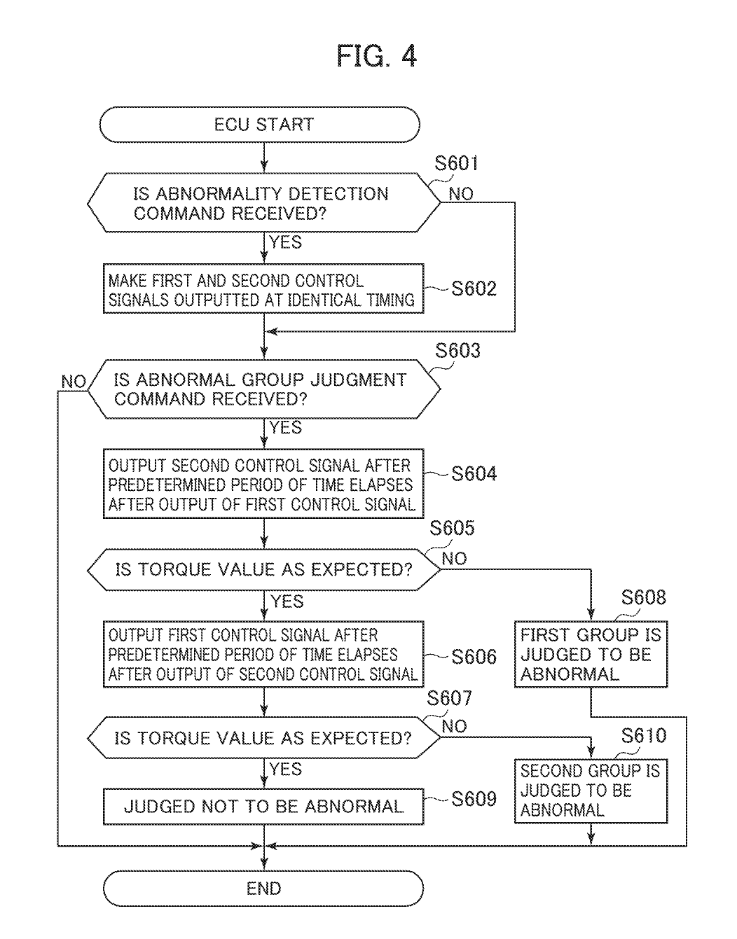

FIG. 4 is a flowchart showing operations of a first ECU 16 and a second ECU 26. A subject that executes the steps explained below is a CPU of each of the first ECU 16 and the second ECU 26. The first ECU 16 and the second ECU 26 execute the program showing operations in the flowchart of FIG. 4 every predetermined period of time. The program, however, maybe executed by being triggered by the reception of some sort of command from an abnormality detector 300.

At Step S601, whether or not an abnormality detection command is received from the abnormality detector 300 is iudged. The process advances to Step S602 when the abnormality detection command is judged to be received and the process advances to Step S603 when the abnormality detection command is judged not to be received. At Step S602, the first ECU 16 and the second ECU 26 output PWM signals so that a first control signal may be outputted from a first inverter 15 and a second control signal maybe outputted from a second inverter 25 simultaneously and the process advances to Step S603.

At Step S603, whether or not an abnormal group judgment command is received from the abnormality detector 300 is judged. The process advances to Step S604 when the abnormal group judgment command is iudged to be received and the execution of the program shown in the flowchart of FIG. 4 is finished when the abnormal group judgment command is judged not to be received.

At Step S604, the first ECU 16 and the second ECU 26 stagger the timings of a first control signal and a second control signal from each other and output the first control signal and the second control signal to the first inverter 15 and the second inverter 25 respectively. For example, PWM signals are outputted so that the first control signal may be outputted in advance and the second control signal may start to be outputted when the first control signal is outputted for a predetermined period of time. Here, it is also possible to: change a ratio of amplitudes in place of staggering output timings; and output the first control signal and the second control signal as stated earlier. At subsequent Step S605, a difference between a torque detected by a motor torque sensor 3 and an assumed torque is evaluated and the process advances to Step S606 when the difference between the detected torque and the assumed torque is judged to be only less than a predetermined value and the process advances to Step S608 when the difference between the detected torque and the assumed torque is judged to be the predetermined value or more.

At Step S606, the first ECU 16 and the second ECU 26 output PWM signals so that the outputs may be reversed from the outputs at Step s604 chronologically, in other words so that the second control signal may be outputted in advance and the first control signal may start to be outputted when the second control signal is outputted for a predetermined period of time. At subsequent Step S607, a difference between a torque detected by the motor torque sensor 3 and an assumed torque is evaluated and the process advances to Step S609 when the difference between the detected torque and the assumed torque is judged to be only less than a predetermined value and the process advances to Step S610 when the difference between the detected torque and the assumed torque is judged to be the predetermined value or more.

At Step S608 that is executed when negative judgment is given at Step S605, a first group A is judged to have an abnormality, the judgment result is outputted to the abnormality detector 300, and the execution of the program showing the operations in the flowchart of FIG. 4 is finished.

At Step S609 that is executed when affirmative judgment is given at Step S607, both the first group A and a second group B are judged to have no abnormalities, the judgment result is outputted to the abnormality detector 300, and the execution of the program showing the operations in the flowchart of FIG. 4 is finished.

At Step S610 that is executed when negative judgment is given at Step S607, the second group B is judged to have an abnormality, the judgment result is outputted to the abnormality detector 300, and the execution of the program showing the operations in the flowchart of FIG. 4 is finished.

According to the first embodiment stated above, the following operational advantages are obtained.

(1) An actuator system, for example an electric power steering system 100 has: a motor 1 drivable in two directions; first and second actuator control sections, for example a first inverter 15 and a second inverter 25, to output control signals to the motor 1; and an abnormality detection section 30 to control the inverter 5 through an ECU 6. The abnormality detection section 30 detects an abnormality by making the first inverter 15 output a first control signal to drive the motor 1 in a first direction, for example in a clockwise direction, and making the second inverter 25 output a second control signal to drive the motor 1 in a second direction that is paired with the first direction, for example in a counterclockwise direction.

As a result, by using a redundant configuration and executing conflicting operations and by evaluating a result of offsetting the respective actions, whether or not the redundant configuration is operating appropriately or whether or not there is some sort of problem in the configuration can be detected. That is, whether or not a redundant configuration has an abnormality can be detected on the basis of a single operation command.

(2) An abnormality detection section 30 detects an abnormality on the basis of an equilibrium state of a motor 1 when first and second control signals are outputted. As a result, whether or not an abnormality exits can be detected easily by simply judging whether or not the motor 1 is in the equilibrium state.

(3) An abnormality detection section 30 makes a first inverter 15 and a second inverter 25 output signals of the same magnitude at the same timing respectively as a first control sianal and a second control signal. As a result, whether or not an abnormality exits can be detected by whether or not a sum of the output torques of a first motor 11 and a second motor 21 is always zero. Further, a transient state can also be evaluated.

(4) An abnormality detection section 30 makes a first inverter 15 and a second inverter 25 output amplitude signals of phases reverse to each other as a first control signal and a second control signal respectively. As a result, in the two signals outputted to a first motor 11 and a second motor 21, one signal can be generated easily on the basis of the other signal.

(5) A torque generated in a motor 1 by a first control signal and a torque generated in the motor 1 by a second control signal are larger than a friction torque of the motor 1. As a result, the motor 1 operates when some kind of problem occurs in a first group A or a second group B and hence an abnormality can be detected by detecting the movement of the motor 1.

(6) An electric power steering system 100 is incorporated into a vehicle and an abnormality detection section 30 makes a first inverter 15 and a second inverter 25 output a first control signal and a second control signal when the vehicle is started, in other words when the power source of electrical components is turned on. As a result, an abnormality can be detected before the vehicle is started.

(7) An abnormality detection section 30 can: detect at least one of a rotation torque, a rotational speed, a rotation amount, and a rotational acceleration of a motor 1 and judge the equilibrium state of the motor 1 on the basis of an output of a motor torque sensor 3 to detect a rotation torque of the motor 1, a motor rotation sensor 2 to detect rotation of the motor 1, or a steering angle sensor 4 to detect a steering angle based on steering of a steering wheel 201 installed in a vehicle by a user and rotation of the motor 1; and judge an equilibrium state of the motor 1. As a result, an equilibrium state can be judged even when a user does not hold a steering wheel 201.

(8) An abnormality detection section 30 can detect a rotation torque of a motor 1 and judge an equilibrium state of the motor 1 on the basis of an output of a steering torque sensor 9 to detect a steering torque generated by steering of a steering wheel 201 installed in a vehicle and rotation of the motor 1. As a result, an equilibrium state can be judged by using the steering torque having a higher sensitivity than a motor rotation senor 2 and a steering angle sensor 4 when a user holds the steering wheel 201.

(9) An abnormality detection section 30 specifies which of a first group A including a first inverter 15 or a second aroup B including a second inverter 25 has an abnormality by staggering timings of outputting a first control sianal and a second control signal or differentiating the maanitudes of the first control signal and the second control signal when the abnormality detection section 30 detects the abnormality. As a result, not only whether or not an abnormality exists but also which of the first group A and the second group B has an abnormality can be identified.

(10) An abnormality detection section 30 stops a group including an inverter 5 identified as having an abnormality, namely a first group A or a second group B. As a result, it is possible to operate an electric power steering system 100 by using only a croup where an abnormality is not detected.

(11) An abnormality detector 300 is used in an electric power steering system 100 having a motor 1 drivable in two directions and first and second actuator control sections, for example a first inverter 15 and a second inverter 25, to output control signals to the motor 1. The abnormality detector 300 has an abnormality detection section 30 to control the first inverter 15 and the second inverter 25 through an ECU 6. The abnormality detection section 30 detects an abnormality by making the first inverter 15 output a first control signal to drive the motor 1 in a first direction, for example in a clockwise direction, and making the second inverter 25 output a second control signal to drive the motor 1 in a second direction that is paired with the first direction, for example in a counterclockwise direction.

The embodiments stated above may be modified as follows.

### Modified Example 1

A period of time when a first ECU 16 and a second ECU 26 output PWM signals: is a predetermined period of time or shorter, which is sufficiently shorter than a period of time spent until rated revolutions are reached; and may be an extent of time allowing so-called inching operation. Even when either of processing groups has an abnormality, it is possible to suppress the amount of rotation of a steering wheel 201 and reduce an uncomfortable feeling of a user.

### Modified Example 2

An abnormality detector 300 may make control signals divided into several pieces and outputted to a motor 1 by making a first ECU 16 and a second ECU 26 divide each of PWM sianals into several pieces and output the divided pieces. Even when either of processing groups has an abnormality, since a static friction force is larger than a dynamic friction force, it is possible to suppress the amount of rotation of a steering wheel 201 and reduce an uncomfortable feeling of a user.

### Modified Example 3

A first ECU 16 and a second ECU 26 may physically be a single ECU. Otherwise, an abnormality detection section 30 may be configured integrally with the first ECU 16 or the second ECU 26.

### Modified Example 4

An abnormality detector 300 may output a judgment result to another abnormality detector installed in an identical vehicle when the judgment result is outputted from an ECU 6.

### Modified Example 5

In an electric power steering system 100, a motor may not be redundant. In other words, an electric power steering system. 100 may be configured so that only one set of wiring wires may be prepared and voltages inputted from a first inverter 15 and a second inverter 25 may be inputted into the identical wiring wires.

### Modified Example 6

Although a first ECU 16 and a second ECU 26 use synchronized timers in order to ensure the simultaneity of processing, it is also possible to ensure the simultaneity of processing by outputting PWM signals after a predetermined period of time has elapsed after an abnormality detection command is received from an abnormality detector 300.

### Modified Example 7

An abnormality detection method explained in the first embodiment can also be applied to another actuator steerable in two directions, for example a drive motor or the like.

### Modified Example 8

A first ECU 16 and a second ECU 26 that have received abnormal group judgment commands may output control signals and judge an abnormality as follows. That is, firstly the first ECU 16 may make a first control signal outputted and judge an abnormality of a first group A on the basis of an output of a motor torque sensor 3 and successively the second ECU 26 may make a second control signal outputted and judge an abnormality of a second group B on the basis of an output of the motor torque sensor 3.

### Modified Example 9

A first ECU 16 and a second ECU 26 that have received abnormality detection commands may stop the output of PWM signals immediately when a motor torque sensor 3 detects a torque after the first ECU 16 and the second ECU 26 output the PWM sianals to an inverter 5. The purpose is to prevent a user from being given an uncomfortable feeling by generating a torque more than necessary because the torque is detected and thus that an equilibrium state does not exist is detected.

Although a program is stored in a ROM not shown in the figures, the program may also be stored in a nonvolatile memory. Further, it is also possible that an abnormality detector 300 and an ECU 6 have an input and output interface not shown in the figures and a program may be read from another device through a medium available to the input and output interface when necessary. The medium cited here means, for example, a storage medium or communication medium detachable to an input and output interface, namely a wired, wireless, or light network, or a carrier wave or a digital signal propagating the network. Furthermore, a part or the whole of a function achieved by a program may be achieved through a hardware circuit or a FPGA.

The embodiments and modified examples stated above may be combined respectively.

Various embodiments and modified examples have been explained above but the present invention is not limited to those contents. Other embodiments that are conceivable within the technological thought of the present invention are also included in the scope of the present invention.

The disclosure of the following priority right basic application is incorporated herein by reference in its entirety:

Japanese Patent Application No. 2016-191118 (filed on Sep. 29, 2016)

### LIST OF REFERENCE SIGNS

1 Motor

2 Motor rotation sensor

3 Motor torque sensor

4 Steering angle sensor

5 Inverter

9 Steering torque sensor

12 First motor rotation sensor

13 First motor torque sensor

14 First steering angle sensor

15 First inverter

17 First signal generator

18 First abnormal group judgment section

19 First steering torque sensor

22 Second motor rotation sensor

23 Second motor torque sensor

24 Second steering angle sensor

25 Second inverter

27 Second signal generator

28 Second abnormal group judgment section

29 Second steering torque sensor

30 Abnormality detection section

100 Electric power steering system

300 Abnormality detector

1. An actuator system, comprising:
an actuator drivable in two directions;
first and second actuator control sections to output control signals to the actuator; and
an abnormality detection section to control the first and second actuator control sections,
wherein the abnormality detection section detects abnormality by making the first actuator control section output a first control signal to drive the actuator in a first direction and making the second actuator control section output a second control signal to drive the actuator in a second direction that is paired with the first direction.

2. The actuator system according to claim 1,
wherein the abnormality detection section detects abnormality on the basis of an equilibrium state of the actuator appearing when the first and second control signals are outputted.

3. The actuator system according to claim 2,
wherein the abnormality detection section makes the first and second actuator control sections output signals of the same magnitude at the same timing respectively as the first and second control signals.

4. The actuator system according to claim 3,
wherein the abnormality detection section makes the first and second actuator control sections output amplitude signals of reverse phases respectively as the first and second control signals.

5. The actuator system according to claim 1,
wherein a torque generated in the actuator by the first control signal and a torque generated in the actuator by the second control signal are larger than a friction torque of the actuator.

6. The actuator system according to claim 1,
wherein the actuator system is incorporated in a device, and
the abnormality detection section makes the first and second actuator control sections output the first and second control signals when the device is activated.

7. The actuator system according to claim 2,
wherein the actuator is a power steering motor mounted on a vehicle, and
the abnormality detection section judges an equilibrium state of the power steering motor on the basis of at least one of a stroke of a rack bar of the vehicle driven by the power steering motor in a linear direction, and a rotation torque, a rotational speed, a rotation amount, and a rotational acceleration of the power steering motor.

8. The actuator system according to claim 7,
wherein the abnormality detection section detects at least one of a rotation torque, a rotational speed, a rotation amount, and a rotational acceleration of the power steering motor and judges an equilibrium state of the power steering motor on the basis of an output of a motor torque sensor to detect a rotation torque of the power steering motor, a rotation sensor to detect a rotation of the power steering motor, or a steering angle sensor to detect a steering angle based on steering of a steering wheel installed in the vehicle and rotation of the power steering motor.

9. The actuator system according to claim 7,
wherein the abnormality detection section detects a rotation torque of the power steering motor and judges an equilibrium state of the power steering motor on the basis of an output of a steering torque sensor to detect a steering torque generated by steering of a steering wheel installed in the vehicle and rotation of the power steering motor.

10. The actuator system according to claim 1,
wherein a time required of the abnormality detection section for making the first control signal and the second control signal outputted is a predetermined time or shorter.

11. The actuator system according to claim 1,
wherein the abnormality detection section makes the first control signal and the second control signal outputted several times in a divided manner.

12. The actuator system according to claim 3,
wherein the abnormality detection section specifies which of the first actuator control section and the second actuator control section has abnormality by staggering timings of outputting the first control sianal and the second control signal when abnormality is detected or differentiating magnitudes of the first control signal and the second control signal.

13. The actuator system according to claim 12,
wherein the abnormality detection section stops the first actuator control section or the second actuator control section, which is identified as having an abnormality.

14. An abnormality detector used in an actuator system having an actuator drivable in two directions and first and second actuator control sections to output control signals to the actuator,
wherein the abnormality detector has an abnormality detection section to control the first and second actuator control sections, and
the abnormality detection section detects abnormality by making the first actuator control section output a first control signal to drive the actuator in a first direction and making the second actuator control section output a second control signal to drive the actuator in a second direction that is paired with the first direction.
